(19) United States
(12) Patent Application Publication
(10) Pub. No.: US 2013/0041806 A1
(43) Pub. Date: Feb. 14, 2013

(54) System and Method for Identifying Banking Errors

(71) Applicants: Robert Bruce Levy, Framingham, MA (US); Bernard Paul LeCuyer, JR., Milford, NH (US)

(72) Inventors: Robert Bruce Levy, Framingham, MA (US); Bernard Paul LeCuyer, JR., Milford, NH (US)

(73) Assignee: HARTE-HANKS DATA TECHNOLOGIES, INC., Billerica, MA (US)

(21) Appl. No.: 13/546,784

(22) Filed: Jul. 11, 2012

Related U.S. Application Data
(60) Provisional application No. 61/506,356, filed on Jul. 11, 2011.

(51) Int. Cl. G06Q 40/02

(52) U.S. Cl. 705/38

(57) ABSTRACT

A computer-implemented method for customer relationship management is provided. The method may include receiving bank data including bank lending credit risk management data. The method may further include receiving one or more business rules configured to perform computations upon the bank data. The method may also include identifying one or more anomalies associated with at least one of a credit risk modeling calculation and a capital adequacy calculation based upon, at least in part, the bank data. The method may additionally include generating at least one report identifying at least one loan data record for investigation.

### CROSS-REFERENCE TO RELATED APPLICATIONS

This application claims the benefit of U.S. provisional patent application Ser. No. 61/506,356, entitled “Error Detection System and Method” filed on, Jul. 11, 2011, the entire disclosure of which application is incorporated herein by reference.

### TECHNICAL FIELD

This disclosure relates to the banking industry and, more particularly, to a system and method for identifying banking errors associated with bank loan data.

### BACKGROUND

Business Unit leaders at large banks worldwide face an ever increasing drain of capital from their business which regulators require the bank hold in reserve against risk. This “regulatory capital” problem currently accounts for nearly a trillion dollars held idle within United States banks, significantly more worldwide.

Many countries' capital adequacy regulations, including those in the United States, permit specific banks to make use of internal loans data for the purpose of deriving key parameters. These key parameters may be used in determining how much capital the bank must hold to comply with regulatory requirements. With the advent of model-based approaches which permit banks to leverage their own data as input to supervisory formulae for determining required regulatory capital, clean data underlying said computations is critical.

Bank business leaders presuppose this problem “is what it is” as their best minds apply math to better model risk. However, there is a disconnect between IT-minded teams responsible for clean data vs. depth of understanding how that data impacts the business through the credit risk modeling process.

### SUMMARY OF DISCLOSURE

In one implementation, a computer-implemented method for customer relationship management is provided. The method may include receiving bank data including bank lending credit risk management data. The method may further include receiving one or more business rules configured to perform computations upon the bank data. The method may also include identifying one or more anomalies associated with at least one of a credit risk modeling calculation and a capital adequacy calculation based upon, at least in part, the bank data. The method may additionally include generating at least one report identifying at least one loan data record for investigation.

One or more of the following features may be included. In some embodiments, the bank data may include at least one of a customer information, an obligor information, and a loan performance history. The one or more business rules may include at least one functional description of a data scenarios to be flagged as anomalous. The one or more business rules may be configured to select a particular rule best suited to at least one of a given asset class and a credit risk model parameter of interest. The one or more anomalies may be identified in accordance with a prescribed set of rules, patterns or heuristics. The generated report may be identified for a data cleansing activity. The generated report may be configured to quantify an estimate of anticipated recoverable regulatory capital. The generated report may be configured to present one or more loans in an order corresponding to priority.

In another implementation, a computer program product residing on a computer readable storage medium is provided. The computer program product may have a plurality of instructions stored thereon, which when executed by a processor, cause the processor to perform operations. Operations may include receiving bank data including bank lending credit risk management data. Operations may further include receiving one or more business rules configured to perform computations upon the bank data. Operations may also include identifying one or more anomalies associated with at least one of a credit risk modeling calculation and a capital adequacy calculation based upon, at least in part, the bank data. Operations may additionally include generating at least one report identifying at least one loan data record for investigation.

One or more of the following features may be included. In some embodiments, the bank data may include at least one of a customer information, an obligor information, and a loan performance history. The one or more business rules may include at least one functional description of a data scenarios to be flagged as anomalous. The one or more business rules may be configured to select a particular rule best suited to at least one of a given asset class and a credit risk model parameter of interest. The one or more anomalies may be identified in accordance with a prescribed set of rules, patterns or heuristics. The generated report may be identified for a data cleansing activity. The generated report may be configured to quantify an estimate of anticipated recoverable regulatory capital. The generated report may be configured to present one or more loans in an order corresponding to priority.

In another implementation, a computing system having one or more processors is provided. The one or more processors may be configured to receive bank data including bank lending credit risk management data. The one or more processors may be further configured to receive one or more business rules configured to perform computations upon the bank data. The one or more processors may be further configured to identify one or more anomalies associated with at least one of a credit risk modeling calculation and a capital adequacy calculation based upon, at least in part, the bank data. The one or more processors may be further configured to generate at least one report identifying at least one loan data record for investigation.

One or more of the following features may be included. In some embodiments, the bank data may include at least one of a customer information, an obligor information, and a loan performance history. The one or more business rules may include at least one functional description of a data scenarios to be flagged as anomalous. The one or more business rules may be configured to select a particular rule best suited to at least one of a given asset class and a credit risk model parameter of interest. The one or more anomalies may be identified in accordance with a prescribed set of rules, patterns or heuristics. The generated report may be identified for a data cleansing activity. The generated report may be configured to quantify an estimate of anticipated recoverable regulatory capital. The generated report may be configured to present one or more loans in an order corresponding to priority.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a identification process coupled to a distributed computing network;

FIG. 2 is a flowchart of the identification process of FIG. 1; and

FIG. 3 is a system diagram corresponding to aspects of the identification process of FIG. 1.

Like reference symbols in the various drawings may indicate like elements.

### DETAILED DESCRIPTION OF THE EMBODIMENTS

### System Overview:

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Embodiments disclosed herein are directed towards a computer-implemented method for the purpose of directing data cleansing work of bank data underlying calculations of regulatory capital. Accordingly, by basing these calculations on corrected data, the teachings of the present disclosure may be used to enable banks to overcome otherwise conservative model assumptions, thereby lowering the required regulatory capital.

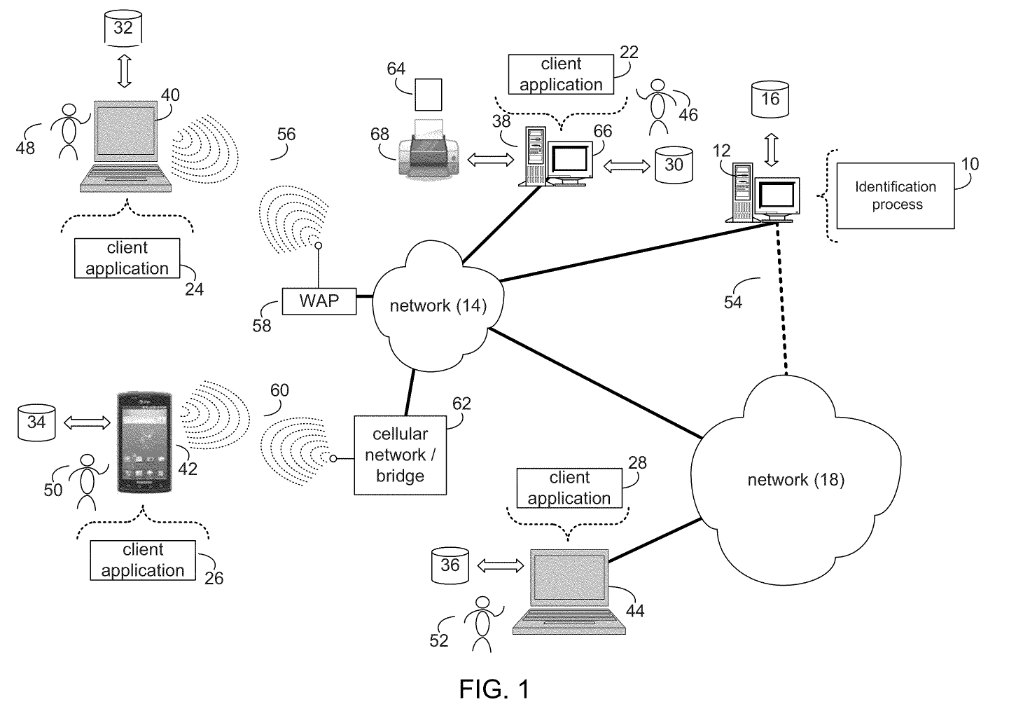

Referring to FIG. 1, there is shown identification process 10 that may reside on and may be executed by computer 12, which may be connected to network 14 (e.g., the Internet or a local area network). Examples of computer 12 may include but are not limited to a single server computer, a series of server computers, a single personal computer, a series of personal computers, a mini computer, a mainframe computer, or a computing cloud. The various components of computer 12 may execute one or more operating systems, examples of which may include but are not limited to: Microsoft Windows Server™; Novell Netware™; Redhat Linux ™, Unix, or a custom operating system, for example.

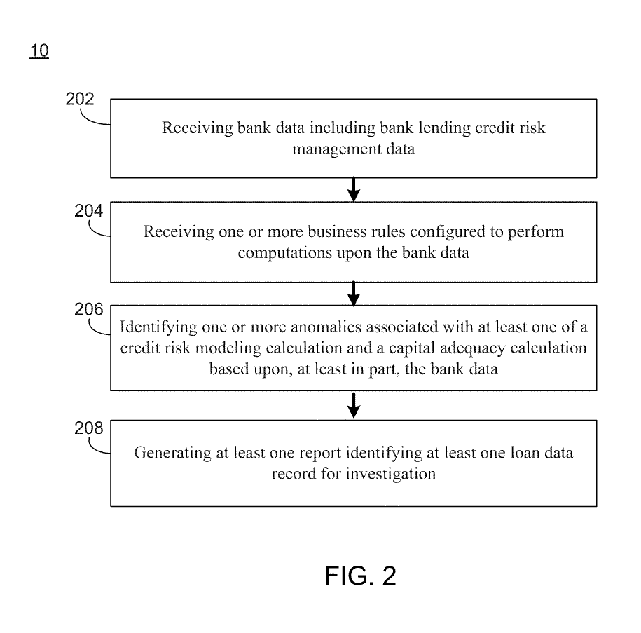

Referring also to FIG. 2, and as will be discussed below in greater detail, identification process 10 may include receiving (202), at one or more computing devices, bank data including bank lending credit risk management data. Identification process 10 may further include receiving (204), at the one or more computing devices, one or more business rules configured to perform computations upon the bank data. Identification process 10 may also include identifying (206), using the one or more computing devices, one or more anomalies associated with at least one of a credit risk modeling calculation and a capital adequacy calculation based upon, at least in part, the bank data. Identification process 10 may further include generating (208), using the one or more computing devices, at least one report identifying at least one loan data record for investigation.

The instruction sets and subroutines of identification process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Identification process 10 may be accessed via client applications 22, 24, 26, 28. Examples of client applications 22, 24, 26, 28 may include but are not limited to a standard web browser, a customized web browser, or a custom application. The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively).

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, notebook computer 44, a server (not shown), a data-enabled, cellular telephone (not shown), and a dedicated network device (not shown).

One or more of client applications 22, 24, 26, 28 may be configured to effectuate some or all of the functionality of identification process 10. Accordingly, identification process 10 may be a purely server-side application, a purely client-side application, or a hybrid server-side/client-side application that is cooperatively executed by one or more of client applications 22, 24, 26, 28 and identification process 10.

Users 46, 48, 50, 52 may access computer 12 and identification process 10 directly through network 14 or through secondary network 18. Further, computer 12 may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Smart phone 42 is shown wirelessly coupled to network 14 via wireless communication channel 60 established between smart phone 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and smart phones to be interconnected using a short-range wireless connection.

Client electronic devices 38, 40, 42, 44 may each execute an operating system, examples of which may include but are not limited to Apple iOS™, Microsoft Windows™, Android™, Redhat Linux™, or a custom operating system.

Embodiments disclosed herein are directed towards an identification process, which may be suitable for use in the banking industry. Embodiments of the identification process described herein may be used to apply data profiling software methods to bank data in the context of credit risk modeling and capital adequacy calculations. Accordingly, identification process 10 may be implemented in one or more applications, for example, for the purpose of directing data cleansing work of bank data underlying calculations of regulatory capital. As discussed above, many countries' capital adequacy regulations permit specific banks to make use of internal loans data for the purpose of deriving key parameters used in determining how much capital the bank must hold to comply with regulatory requirements. By basing these calculations on corrected data, embodiments of the identification process described herein may enable banks to overcome otherwise conservative model assumptions, thereby lowering the required regulatory capital.

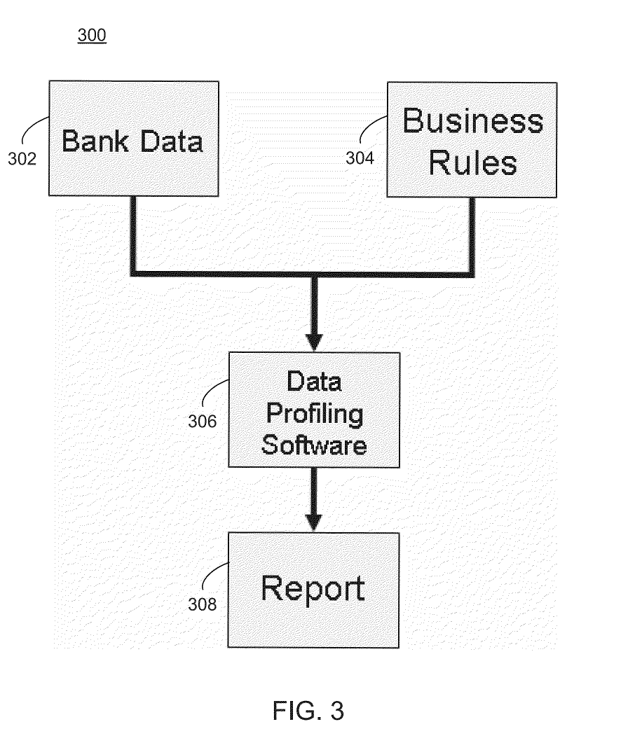

Referring now to FIG. 3, in some embodiments, identification process 10 may include one or more subsystems, which may be configured to identify certain data anomalies, which, if resolved, may lead to improving a bank's regulatory capital requirement. Some subsystems may include, but are not limited to, a first subsystem 302 for managing data of use in modeling credit risk, as input into capital adequacy/regulatory capital calculations. In some embodiments, first subsystem 302 may include bank data, as shown in FIG. 3. In some embodiments, the phrase “bank data” as used herein, may refer to any and all data used or useful in the management of credit risk within bank lending. This may include, but is not limited to, data a bank may input into its credit risk models underlying capital adequacy computations. While this may differ by bank, common data fields may include, but are not limited to, customer/obligor fields, loan performance history, etc. This data may often be gathered from across disparate data systems within a particular bank as input into the credit risk modeling process and used separately as an input into in certain embodiments of the present disclosure.

Identification process 10 may further include a second subsystem 304, which may be configured to manage business rules used by data profiling software. In some embodiments, the phrase “business rules” as used herein, may refer to specific software instructions executed by the data profiling software. For example, using the TS-Discovery product component available from the Assignee of the present disclosure, these may consist of functional descriptions of data scenarios to be flagged as anomalous. Additionally and/or alternatively, business rules may or may not comprise a system of managing business rules for the purpose of selecting those rules best suited to a given asset class and credit risk model parameter of interest. Accordingly, in some embodiments, this may be implemented as software, new software feature within existing data profiling software, configuration of external software such as Microsoft® Excel, or other similar means.

Identification process 10 may also include a third subsystem 306 (e.g., data profiling software subsystem). In some embodiments, the phrase “data profiling software” as used herein, may refer to any known or to be developed system used in identifying data anomalies per a prescribed set of rules, patterns or heuristics.

Identification process 10 may also include a fourth subsystem 308, which may be configured to produce reports identifying specific loan data records meriting investigation and cleansing for the purpose of recovering regulatory capital being held in error. In some embodiments, the term “report” as used herein, may refer to the programmed and configured output of the data profiling software subsystem, such that specific loans may be identified for the purpose of data cleansing activity. Data cleansing activities performed may be automated or manual. Additionally and/or alternatively, a report may also quantify an estimate and/or range of anticipated recoverable regulatory capital resulting from addressing data anomalies identified. A report may present one or more loans in sequence of the priority or business value of data cleansing activity. In some embodiments, this prioritization may be based upon weighting of business rules described above and the combined weight of said rules as identify anomaly to each given loan data record from the bank data described above.

Embodiments of identification process 10 may also include an ongoing monitoring component whereby some or all of the methods described herein may be applied and metrics may be provided on the overall health of data at a point in time, in terms of regulatory capital impact.

In some embodiments, one or more tests may be utilized in accordance with the identification process described herein. Some of the tests that uniquely identify the opportunity to lower regulatory capital are provided below. These tests are enabled using the teachings of the present disclosure and may be executed against a bank's historical loan data for the loan categories listed below. These computer-implemented tests may be applied to the data with resulting loan entries that failed the tests being displayed in a report as discussed above.

In some embodiments, a retail mortgage loan test may include identifying loans flagged as in default (usually a boolean field) for which the obligor has not missed a payment (various fields referring to past due/highest past due) or which has not been fully/partially charged off. Find any loan flagged as default but is less than 180 days past due and bank didn't take charge off. The test may also involve determining the difference between banks default days and regulatory days. In some embodiments, the retail mortgage test may include identifying one or more loans with high obligor FICOs (>625?) flagged as in default. A determination may be made as to whether the loan is actually in default. The retail mortgage test may also include a determination regarding whether any segments of retail exposures with PD>100%. In some embodiments, the LGD may be <10% for a segment of retail exposure if guaranteed by sovereign entity. Additionally and/or alternatively, the retail mortgage test may include a determination as to which loans within segments of unseasoned retail exposures have since become seasoned and now are misclassified. Are any higher risk credit exposures miscategorized within the asset class being analyzed for PD. An calculation of retail+low debt income ratio+default may be performed. The retail mortgage test may include an analysis of whether there is a good internal risk score but default occurred. The retail mortgage test may include an analysis of whether there is a low payments+high net worth+defaulted or a low fixed interest+default and whether or not there are missing fico scores.

In some embodiments, a retail automobile loan test may include identifying one or more loans flagged as in default (usually a boolean field) for which the obligor has not missed a payment (various fields referring to past due/highest past due) or which has not been fully/partially charged off. The retail automobile test may include determining any loan flagged as default but is less than 120 days past due and bank didn't take charge off. The test may also involve determining the difference between banks default days and regulatory days. Again, in some embodiments, the retail automobile test may include identifying one or more loans with high obligor FICOs (>625?) flagged as in default. A determination may be made as to whether the loan is actually in default. The retail automobile test may also include a determination regarding whether any segments of retail exposures with PD>100%. Accordingly, the retail automobile may include any or all of the tests outlined above with reference to the retail mortgage test.

In some embodiments, a retail credit card test may include identifying one or more loans flagged as in default (usually a boolean field) for which the obligor has not missed a payment (various fields referring to past due/highest past due) or which has not been fully/partially charged off. In some embodiments, the retail credit card test may include determining any loan flagged as default but that is less than 180 days past due and bank didn't take charge off. Accordingly, the retail credit card test may include any or all of the tests outlined above with reference to the retail mortgage test.

In some embodiments, a retail student loan test may include identifying one or more loans flagged as in default (usually a boolean field) for which the obligor has not missed a payment (various fields referring to past due/highest past due) or which has not been fully/partially charged off. In some embodiments, the retail student loan test may include determining any loan flagged as default but is less than 120 days past due and bank didn't take charge off. Again, the retail automobile may include any or all of the tests outlined above with reference to the retail student loan test may include any or all of the additional tests identified herein (e.g. retail mortgage, etc). Similar tests may be applied to various other consumer loans as well.

In some embodiments, a wholesale corporate loan test may include identifying one or more loans flagged as in default (usually a boolean field) for which the obligor has not missed a payment (various fields referring to past due/highest past due) or which has not been fully/partially charged off. In some embodiments, the wholesale corporate loan test may include determining any loan “flagged as in default” for which max # days past-due is less than 90. In some embodiments, “flagged as in default”=either an explicit “default” “dflt” etc boolean, and/or use of LDFL fields. The test may also involve determining the difference between banks default days and regulatory days. The wholesale corporate loan test may include determining whether there is any wholesale exposure where the guarantor PD is lower than obligor PD. (If so, use substitution PD of guarantor). Additional factors may include determining if a wholesale high D&B/Paydex etc+entity still solvent yet defaulted. Accordingly, the wholesale corporate test may include any or all of the tests outlined above with reference to the other tests.

In some embodiments, a wholesale bank loan test may include identifying loans flagged as in default (usually a boolean field) for which the obligor has not missed a payment (various fields referring to past due/highest past due) or which has not been fully/partially charged off. In some embodiments, the wholesale bank loan test may include determining any loan “flagged as in default” for which max # days past-due is less than 90. In some embodiments, “flagged as in default”=either an explicit “default” “dflt” etc boolean, and/or use of LDFL fields. The wholesale bank loan test may include determining whether there were any wholesale exposures where the guarantor PD is lower than obligor PD? (If so, use substitution PD of guarantor). Again, the wholesale bank loan test may include any or all of the tests outlined above with reference to the other tests. Similar tests may be applied to sovereign loan tests as well.

In some embodiments, the present disclosure may address issues related to general risk based capital. For example, with regard retail mortgages some determinations may be made. Specifically, as to whether the retail mortgages are assigned the correct risk weight of 50%. (e.g., if classified incorrectly, could lower or increase RWA). Determine whether trial or permanent HAMP modified loans have risk weights of 50% (Could reduce capital if assigned 100% risk weight). Determine whether any asset risk weighted at more than 100%? (If so, this could decrease RWA; no risk weight is higher than 100%; with exceptions). Determine whether all assets fall within defined risk weights of 0, 20, 50, or 100? (If not, bank may be using different Basel approach). Identify retail loans that have been sold but are still on the books. (Since loans are sold, no longer have to hold capital against them). Identify retail loans that have been paid in full or paid off, but are still on the books. (Again, loans are paid off, so should not hold capital against them). Identify retail loans with LTV>than 100 (should the bank loan more than 100% of the value of an asset). Identify any loans adversely classified as “loss” that have not been charged off.

In some embodiments, and with regard to retail automobile loans testing, a number of determinations may be involved. These may include determining whether any asset risk is weighted at more than 100%. (If so, this could decrease RWA; no risk weight is higher than 100%; with exceptions). Identify retail loans that have been sold but are still on the books. (Since loans are sold, no longer have to hold capital against them). Identify retail loans that have been paid in full or paid off, but are still on the books? (Again, loans are paid off, so should not hold capital against them). Identify any loans adversely classified as “loss” that have not been charged off

In some embodiments, and with regard to retail credit card loans testing, a number of determinations may be involved. These may include determining if any asset risk weighted at more than 100%. (If so, this could decrease RWA; no risk weight is higher than 100%; with exceptions). Identifying retail loans that have been sold but are still on the books. (Since loans are sold, no longer have to hold capital against them). Identifying retail loans that have been paid in full or paid off, but are still on the books. (Again, loans are paid off, so should not hold capital against them). Identify any loans adversely classified as “loss” that have not been charged off.

In some embodiments, and with regard to retail student loans testing, a number of determinations may be involved. These may include determining if any asset risk weighted at more than 100%. (If so, this could decrease RWA; no risk weight is higher than 100%; with exceptions). Identifying retail loans that have been sold but are still on the books. (Since loans are sold, no longer have to hold capital against them). Identify retail loans that have been paid in full or paid off, but are still on the books. (Again, loans are paid off, so should not hold capital against them). Identifying any loans adversely classified as “loss” that have not been charged off

In some embodiments, and with regard to other consumer loans testing, a number of determinations may be involved. These may include determining if any asset risk weighted at more than 100%, (If so, this could decrease RWA; no risk weight is higher than 100%; with exceptions). Identifying retail loans that have been sold but are still on the books? (Since loans are sold, no longer have to hold capital against them). Identifying retail loans that have been paid in full or paid off, but are still on the books? (Again, loans are paid off, so should not hold capital against them). Identifying any loans adversely classified as “loss” that have not been charged off

In some embodiments, and with regard to wholesale corporate testing, a number of determinations may be involved. These may include identify wholesale exposures that have been sold but are still on the books. (Since loans are sold, no longer have to hold capital against them). Identifying wholesale exposures that have been paid in full or paid off, but are still on the books. (Again, loans are paid off, so should not hold capital against them). Identifying any loans adversely classified as “loss” that have not been charged off.

In some embodiments, and with regard to wholesale banks testing, a number of determinations may be involved. These may include identify identifying wholesale exposures that have been sold but are still on the books. (Since loans are sold, no longer have to hold capital against them). Identifying wholesale exposures that have been paid in full or paid off, but are still on the books. (Again, loans are paid off, so should not hold capital against them). Identifying any loans adversely classified as “loss” that have not been charged off

In some embodiments, and with regard to wholesale sovereigns testing, a number of determinations may be involved. These may include identifying wholesale exposures that have been sold but are still on the books. (Since loans are sold, no longer have to hold capital against them). Identifying wholesale exposures that have been paid in full or paid off, but are still on the books. (Again, loans are paid off, so should not hold capital against them). Identifying any loans adversely classified as “loss” that have not been charged off.

In some embodiments, identification process 10 may allow for tests from insights into the credit risk model. In the retail mortgage example, some determinations may include identifying retail line account where loan balance<0. Identifying retail line account where loan balance=extraordinary number (TBD). Identifying retail line account where loan balance=0. Identify duplicate inputs/accounts. Identifying defaulted loans where flagged as fraud or identity theft. Identifying accounts with collection balance<$100. Identifying defaulted accounts that are >7 years old. Identifying accounts with FICO score>850. Identifying accounts with FICO score<300. Identifying sales numbers that are <0. Searching for missing data parameters.

In the retail automobile example, some determinations may include identifying retail line account where loan balance<0. Identifying retail line account where loan balance=extraordinary number (TBD). Identifying retail line account where loan balance=0. Identifying duplicate inputs/accounts. Identifying defaulted loans where flagged as fraud or identity theft. Identifying accounts with collection balance<$100. Identifying defaulted accounts that are >7 years old. Identifying accounts with FICO score>850. Identifying accounts with FICO score<300. Identifying sales numbers that are <0. Searching for missing data parameters

In the retail credit card example, some determinations may include identifying retail line account where loan balance<0. Identifying retail line account where loan balance=extraordinary number (TBD). Identifying retail line account where loan balance=0. Identifying duplicate inputs/accounts. Identifying defaulted loans where flagged as fraud or identity theft. Identify defaulted accounts where flagged as lost or stolen card. Identifying accounts with collection balance<100. Identify defaulted accounts that are >7 years old. Identifying accounts with FICO score>850. Identifying accounts with FICO score<300. Identifying sales numbers that are <0. Searching for missing data parameters.

In the retail student loan example, some determinations may include identifying retail line account where loan balance<0. Identifying retail line account where loan balance=extraordinary number (TBD). Identifying retail line account where loan balance=0. Identifying duplicate inputs/accounts. Identifying defaulted loans where flagged as fraud or identity theft. Identifying accounts with collection balance<$100. Identifying defaulted accounts that are >7 years old. Identifying accounts with FICO score>850. Identify accounts with FICO score<300. Identifying sales numbers that are <0. Searching for missing data parameters.

Regarding other consumer loans, some determinations may include identify retail line account where loan balance<0. Identifying retail line account where loan balance=extraordinary number (TBD). Identifying retail line account where loan balance=0. Identifying duplicate inputs/accounts. Identifying defaulted loans where flagged as fraud or identity theft. Identifying accounts with collection balance<$100. Identifying defaulted accounts that are >7 years old. Identifying accounts with FICO score>850. Identifying accounts with FICO score<300. Identifying sales numbers that are <0. Searching for missing data parameters.

In the wholesale corporate loan example, some determinations may include identify instances where assets>(liabilities+equity) on balance sheet. Identifying instances where assets<(liabilities+equity) on balance sheet. Identifying loans where loan balance<0. Identifying instances where financial statements (i.e. balance sheet, income statement, statement of cash flows) <12 months (period ending). Identifying instances where financial statements have inputs of “0” or “null”. Identifying financial ratios (i.e. current ratio, quick ratio, profitability ratio) where denominator is <5% of numerator (5% arbitrary guess). Identifying duplicate inputs/accounts. Identifying extreme ratios (1% and 99% tile). Identifying accounts with D&B score<101. Identifying accounts with D&B score>670.

In the wholesale bank loan example, some determinations may include identify instances where assets>(liabilities+equity) on balance sheet. Identifying instances where assets<(liabilities+equity) on balance sheet. Identifying loans where loan balance<0. Identifying instances where financial statements (i.e. balance sheet, income statement, statement of cash flows) <12 months (period ending). Identifying instances where financial statements have inputs of “0” or “null”. Identifying financial ratios (i.e. current ratio, quick ratio, profitability ratio) where denominator is <5% of numerator (5% arbitrary guess). Identifying duplicate inputs/accounts. Identifying extreme ratios (1% and 99% tile). Identifying accounts with D&B score<101. Identifying accounts with D&B score>670

In the wholesale sovereign loan example, some determinations may include identifying instances where assets>(liabilities+equity) on balance sheet. Identifying instances where assets<(liabilities+equity) on balance sheet. Identifying loans where loan balance<0. Identifying instances where financial statements (i.e. balance sheet, income statement, statement of cash flows)<12 months (period ending). Identifying instances where financial statements have inputs of “0” or “null”. Identifying financial ratios (i.e. current ratio, quick ratio, profitability ratio) where denominator is <5% of numerator (5% arbitrary guess). Identifying duplicate inputs/accounts. Identifying extreme ratios (1% and 99% tile). Identifying accounts with D&B score<101. Identifying accounts with D&B score>670

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, at one or more computing devices, bank data including bank lending credit risk management data;
receiving, at the one or more computing devices, one or more business rules configured to perform computations upon the bank data;
identifying, using the one or more computing devices, one or more anomalies associated with at least one of a credit risk modeling calculation and a capital adequacy calculation based upon, at least in part, the bank data; and
generating, using the one or more computing devices, at least one report identifying at least one loan data record for investigation.

2. The computer-implemented method of claim 1, wherein the bank data includes at least one of a customer information, an obligor information, and a loan performance history.

3. The computer-implemented method of claim 1, wherein the one or more business rules include at least one functional description of a data scenarios to be flagged as anomalous.

4. The computer-implemented method of claim 1, wherein the one or more business rules are configured to select a particular rule best suited to at least one of a given asset class and a credit risk model parameter of interest.

5. The computer-implemented method of claim 1, wherein the one or more anomalies are identified in accordance with a prescribed set of rules, patterns or heuristics.

6. The computer-implemented method of claim 1, wherein the generated report is identified for a data cleansing activity.

7. The computer-implemented method of claim 1, wherein the generated report is configured to quantify an estimate of anticipated recoverable regulatory capital.

8. The computer-implemented method of claim 1, wherein the generated report is configured to present one or more loans in an order corresponding to priority.

9. A computer program product residing on a computer readable storage medium having a plurality of instructions stored thereon, which when executed by a processor, cause the processor to perform operations comprising:
receiving, at one or more computing devices, bank data including bank lending credit risk management data;
receiving, at the one or more computing devices, one or more business rules configured to perform computations upon the bank data;
identifying, using the one or more computing devices, one or more anomalies associated with at least one of a credit risk modeling calculation and a capital adequacy calculation based upon, at least in part, the bank data; and
generating, using the one or more computing devices, at least one report identifying at least one loan data record for investigation.

10. The computer program product of claim 9, wherein the bank data includes at least one of a customer information, an obligor information, and a loan performance history.

11. The computer program product of claim 9, wherein the one or more business rules include at least one functional description of a data scenarios to be flagged as anomalous.

12. The computer program product of claim 9, wherein the one or more business rules are configured to select a particular rule best suited to at least one of a given asset class and a credit risk model parameter of interest.

13. The computer program product of claim 9, wherein the one or more anomalies are identified in accordance with a prescribed set of rules, patterns or heuristics.

14. The computer program product of claim 9, wherein the generated report is identified for a data cleansing activity.

15. The computer program product of claim 9, wherein the generated report is configured to quantify an estimate of anticipated recoverable regulatory capital.

16. The computer program product of claim 9, wherein the generated report is configured to present one or more loans in an order corresponding to priority.

17. A computing system comprising:
one or more processors configured to receive bank data including bank lending credit risk management data, the one or more processors further configured to receive one or more business rules configured to perform computations upon the bank data, the one or more processors further configured to identify one or more anomalies associated with at least one of a credit risk modeling calculation and a capital adequacy calculation based upon, at least in part, the bank data, the one or more processors further configured to generate at least one report identifying at least one loan data record for investigation.

18. The computing system of claim 17, wherein the bank data includes at least one of a customer information, an obligor information, and a loan performance history.

19. The computing system of claim 17, wherein the one or more business rules include at least one functional description of a data scenarios to be flagged as anomalous.

20. The computing system of claim 17, wherein the one or more business rules are configured to select a particular rule best suited to at least one of a given asset class and a credit risk model parameter of interest.

21. The computing system of claim 17, wherein the one or more anomalies are identified in accordance with a prescribed set of rules, patterns or heuristics.

22. The computing system of claim 17, wherein the generated report is identified for a data cleansing activity.

23. The computing system of claim 17, wherein the generated report is configured to quantify an estimate of anticipated recoverable regulatory capital.

24. The computing system of claim 17, wherein the generated report is configured to present one or more loans in an order corresponding to priority.
